(19) United States
(12) Patent Application Publication
(10) Pub. No.: US 2003/0069420 A1
(43) Pub. Date: Apr. 10, 2003

(54) Process for preparing arylboron and alkylboron compounds in microreactors

(75) Inventors: Manfred Koch, Eppstein-Niederjosbach (DE); Detlef Wehle, Brechen (DE); Stefan Scherer, Buttelborn (DE); Klaus Forstinger, Babenhausen (DE); Andreas Meudt, Florsheim-Weilbach (DE)

Correspondence Address: Clariant Corporation, Industrial Property Department, 4000 Monroe Road, Charlotte, NC, 28205, US

(73) Assignee: Clariant GmbH

(21) Appl. No.: 10/210,435

(22) Filed: Aug. 1, 2002

(30) Foreign Application Priority Data
Aug. 11, 2001 (DE) 10139664.3

(51) Int. Cl. C07F 1/00

(52) U.S. Cl. 544/69

(57) ABSTRACT

Process for preparing arylboron and alkylboron compounds of the formulae (II) and (III) by reacting lithioaromatics and lithiated aliphatics of the formula (I) with boron compounds in microreactors in accordance with equation I or equation II,

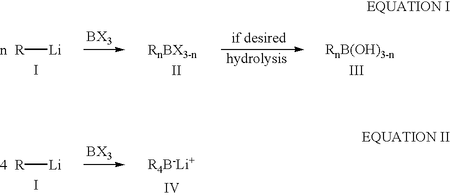

where X=identical or different radicals,

n=1, 2 or 3,

and R=straight-chain or branched C₁-C₆-alkyl, substituted C₁-C₆-alkyl, phenyl substituted by a radical

or

substituted or unsubstituted 6-membered heteroaryl containing one or two nitrogen atoms, or

5-membered heteroaryl containing one or two heteroatoms, or

a substituted or unsubstituted bicyclic or tricyclic aromatic,

in one or more coolable/heatable microreactors connected in series whose outlet channels are, if necessary, connected to capillaries or flexible tubes which are a number of meters in length, with the reaction solutions being intensively mixed during a sufficient residence time. The reaction is preferably carried out at temperatures in the range from −60° C. to +30° C.

The invention relates to a process for preparing arylboron and alkylboron compounds (II) and (III) by reacting lithioaromatics and lithiated aliphatics (I) with boron compounds in microreactors in accordance with equation I or equation II,

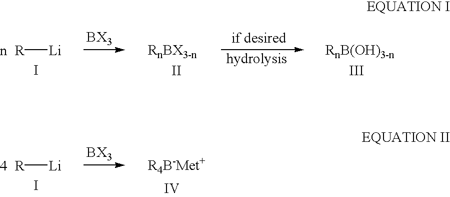

where X=identical or different radicals selected from the group consisting of fluorine, chlorine, bromine, iodine, C₁-C₅-alkoxy, N,N-di(C₁-C₅-alkyl)amino and

(C₁-C₅-alkyl)thio,

n=1, 2 or 3,

and R=straight-chain or branched C₁-C₆-alkyl, C₁-C₆-alkyl substituted by a radical selected from the group consisting of RO, RR′N, phenyl, substituted phenyl, fluorine and RS, phenyl, phenyl substituted by a radical selected from the group consisting of C₁-C₆-alkyl, C₁-C₆-alkoxy, C₁-C₅-thioether, silyl, fluorine, chlorine, dialkylamino, diarylamino and alkylarylamino, 6-membered heteroaryl containing one or two nitrogen atoms, 5-membered heteroaryl containing one or two heteroatoms selected from the group consisting of N, O and S or a substituted or unsubstituted bicyclic or tricyclic aromatic.

Arylboron and alkylboron compounds have in recent years become very versatile synthetic building blocks whose use, e.g. in Suzuki coupling, makes it possible to prepare many economically very interesting fine chemicals, especially for the pharmaceuticals and agrochemicals industries. Mention may be made first and foremost of arylboronic and alkylboronic acids for which the number of applications in the synthesis of active compounds has increased exponentially in recent years. However, diarylborinic acids are also of increasing importance, for example as cocatalysts in the polymerization of olefins or as starting material in Suzuki couplings in which both aryl radicals can be transferred.

The conversion of lithioaromatics and lithiated aliphatics into alkylboron and arylboron compounds has been described in many publications and proceeds in good yields when reaction conditions which are very precisely optimized for the particular case are strictly adhered to.

However, the fact that a wide range of by-products can be formed in amounts which are strongly dependent on the reaction conditions employed is a disadvantage. In principle, possible products after hydrolysis of the reaction mixtures include not only the homocoupling products, i.e. the corresponding biaryls or bialkyls, but also boronic acids, borinic acids, triarylboranes and trialkylboranes and tetraarylboranates or tetraalkylboranates. Apart from the latter charged compounds, the desired reaction products can in each case only be separated off by means of complicated purification operations which reduce the yield and significantly increase the production costs for the products.

In the case of the preparation of arylboronic or alkylboronic acids, the following applies, for example: since there is here a risk of formation of biaryls or bialkyls, borinic acids, boranes and even boranates in which two, three or four equivalents of the organometallic reagent can be consumed, the yield can be decreased severely for this reason when optimum conditions are not adhered to. In many cases, small yields of difficult-to-purify crude products are obtained. A similar situation applies in the preparation of borinic acids, boranes and boranates.

To avoid the abovementioned secondary reactions, the reaction has to be carried out at low temperatures so as to protect the primary products formed in the primary reaction, in the case of the preparation of boronic acids the arylboranates or alkylboranates (V), from decomposition into the free boronic esters or halides (VI),

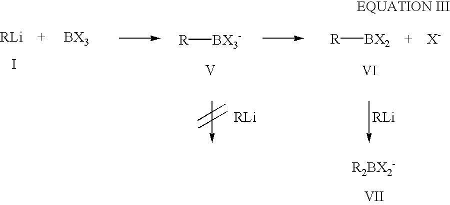

since the latter compete with unreacted BX₃ for further organometallic compound (I) and can thus cause by-product formation and decreases in yield. A very similar situation also occurs in the preparation of more highly alkylated or arylated boron compounds (EQUATION III).

Ideal reaction temperatures are below −35° C., but good results are obtained only at below −50° C. and pure boron compounds and virtually no by-products are obtained at temperatures below −55° C. These temperatures can no longer be achieved industrially by means of cheap cooling methods such as brine cooling, but instead have to be generated at high cost with high energy consumption. Combined with, for example, the preparation of the lithium reagent which is usually carried out at reflux temperature in suitable hydrocarbons and the work-up which generally involves removal of the solvent by distillation, this results in a rather uneconomical, high-cost process in which the following temperature sequence has to be employed: room temperature->reflux (lithiation)->cooling->low temperature (preparation of boronic acid)->room temperature (hydrolysis)->boiling temperature (removal of solvent)->cooling (filtration or extraction).

Another important factor is that the preparation of very many boron compounds via lithium aromatics involves considerable safety risks, since the preparation of many lithium compounds in industrially usable amounts and concentrations is hazardous. Thus, for example, lithium aromatics having adjacent halogen atoms, bearing CF₃ radicals or having C-Cl side chains can decompose spontaneously, especially in the presence of catalytic impurities, which results in the release of tremendous quantities of energy due to the formation of very low-energy lithium halides. In the case of large-scale reactions, serious explosions have to be reckoned with.

Furthermore, it is always necessary to employ an excess of the usually expensive BX₃. In process engineering terms, apart from extremely low temperatures, it is necessary to place BX₃ in the reactor and to add the solution of the lithium compound very slowly dropwise, and this solution should also be added in cooled form. A further factor affecting success is the use of relatively dilute solutions, as a result of which only low space-time yields can be achieved.

There is therefore a need to have a process for preparing arylboron and alkylboron compounds which still employs organolithium compounds and boron compounds BX₃ as raw materials and in which the reaction temperatures are, ideally, above −40° C., and high concentrations of the reactants can be employed without, as in the case of classical process engineering approaches, large amounts of the abovementioned by-products being formed, but which at the same time still gives very high yields of pure boron compounds. Despite numerous efforts, neither we nor other authors have hitherto succeeded in finding appropriate reaction conditions. In addition, an ideal process would at the same time make it possible for boron compounds whose synthesis requires the use of organolithium compounds involving safety concerns to be prepared safely.

The present invention achieves all these objects and provides a process for preparing arylboron and alkylboron compounds (II) and (III) by reacting lithioaromatics and lithiated aliphatics (I) with boron compounds in microreactors in accordance with equation I or equation II,

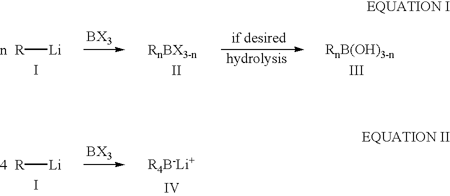

where X=identical or different radicals selected from the group consisting of fluorine, chlorine, bromine, iodine, C₁-C₅-alkoxy, N,N-di(C₁-C₅-alkyl)amino and

(C₁-C₅-alkyl)thio,

n=1, 2 or 3,

and R=straight-chain or branched C₁-C₆-alkyl, C₁-C₆-alkyl substituted by a radical selected from the group consisting of RO, RR′N, phenyl, substituted phenyl, fluorine and RS, phenyl, phenyl substituted by a radical selected from the group consisting of C₁-C₆-alkyl, C₁-C₆-alkoxy, C₁-C₅-thioether, silyl, fluorine, chlorine, dialkylamino, diarylamino and alkylarylamino

or

6-membered heteroaryl containing one or two nitrogen atoms, e.g. pyridine, picoline, pyridazine, pyrimidine or pyrazine, or

5-membered heteroaryl containing one or two heteroatoms selected from the group consisting of N, O and S, e.g. pyrrole, furan, thiophene, imidazole, oxazole or thiazole, or a substituted or unsubstituted bicyclic or tricyclic aromatic, e.g. naphthalene, anthracene or phenanthrene, in one or more coolable/heatable microreactors connected in series whose outlet channels are, if necessary, connected to capillaries or flexible tubes which are a number of meters in length, with the reaction solutions being intensively mixed during a sufficient residence time. When a plurality of microreactors are connected in series, the organolithium compound is generated in the first microreactor by one of the methods of organometallic chemistry which are known to those skilled in the art, fed via a capillary or a flexible tube into a second, downstream microreactor and reacted with BX₃ there.

The work-up of the combined reaction mixtures can be carried out by “classical” work-up and hydrolysis methods.

According to the invention, this process can be carried out continuously.

To carry out the process of the invention, it is possible to use, in particular, flow-through reactors whose channels have a diameter of from 25 microns to 1.5 mm, in particular from 40 microns to 1.0 mm. The flow rate is set so as to give a residence time which corresponds to a conversion of at least 70%. The flow rate in the microreactor is preferably set so that a residence time in the range from one second to 10 minutes, in particular from 10 seconds to 5 minutes, is achieved. In the case of two microreactors connected in series, the residence time in the first reactor including the residence time in the capillary or tube system on the way to the second reactor has to be set so that the conversion in the preparation of the organometallic compound is at least 90%, preferably at least 95%.

Preference is given to using reactors which can be produced by means of technologies employed in the production of silicon chips. However, it is also possible to use comparable reactors which are produced from other materials which are inert toward the lithium solutions and the boron compounds, for example ceramic, glass, graphite or stainless steel or Hastelloy. The microreactors are preferably produced by joining thin silicon structures to one another.

In selecting the miniaturized flow-through reactors to be used, it is important to adhere to the following parameters:

The reaction mixture has to be approximately uniformly mixed in each volume element

The channels have to be sufficiently wide for unhindered flow to be possible without undesirable pressure building up

The structure of the microreactors in combination with the flow rates set has to make possible a residence time which is sufficient to allow a minimum conversion

The system comprising microreactor and discharge tubes or two microreactors connected in series with connecting tubes and discharge tubes has to be able to be cooled and heated.

The conversions according to the invention are advantageously carried out at temperatures of from −60° C. to +30° C., preferably from −50° C. to +25° C., particularly preferably from −40° C. to +20° C.

It is found that the optimum mixing which can be achieved in the microreactors used leads to the very remarkable result that the amount of the abovementioned by-products present in the resulting boron compounds is virtually independent of the reaction temperature. Typical amounts of the by-products mentioned in the boron compounds prepared are, in the case of the preparation of boronic acids, from 0.1 to 3% of borinic acid, <0.1% of borane and amounts of boranates which are below the detection limit. Such selectivities cannot be achieved when using “classical process engineering techniques” even at low temperatures.

The work-up is simple because product purification is no longer necessary. Even in the case of applications having very high purity requirements, the boron compounds obtained can be used directly. A preferred work-up method is, for example, introducing the reaction mixtures into water, acidifying the mixture with mineral acid, distilling off the solvent or solvents and filtering off the pure boron compounds.

In the process of the invention for preparing arylboronic acids, it is possible to achieve, for example, product purities of >99% and yields of >95% in this way.

Suitable solvents for the method of preparing boron compounds according to the invention are aliphatic and aromatic ethers and hydrocarbons and amines which bear no hydrogen on the nitrogen, preferably triethylamine, diethyl ether, tetrahydrofuran, toluene, toluene/THF mixtures and diisopropyl ether, particularly preferably toluene, THF or diisopropyl ether. Preference is given to solutions having concentrations in the range from 1 to 35% by weight, in particular from 5 to 30% by weight, particularly preferably from 8 to 25% by weight.

If the organolithium compound is prepared in an upstream microreactor, it is possible to use all methods of organometallic chemistry which are known to those skilled in the art. Slight variations may be necessary in individual cases because of the particular requirements of the microreaction technique. Thus, for example, it is naturally not possible to prepare lithium aromatics from haloaromatics by reaction with solid lithium metal in a microreactor. Since, however, this is an important and very widely applicable method of producing lithium aromatics, efforts were made to find a solution which can be employed for implementation of such reactions in microreactor technology, and this was also found in the use of “organic redox systems”. For this purpose, lithium metal (granules, pieces, powder, dispersions, bars, rods or other particles) is firstly stirred in a “classical reactor” with one of the numerous organic molecules known to those skilled in the art which can easily take up the free valence electrons of the alkali metal and transfer them efficiently, so as to generate a homogeneous solution of an electron transferrer. This can be, for example, lithium biphenylide, lithium bis-tert-butylbiphenylide or another derivative of monocyclic or polycyclic aromatics. These deeply colored solutions are then reacted in the first microreactor (1) with, for example, a haloaromatic to form the desired organometallic reagent, with the organic electron transferrer being formed again. This can be recycled as often as desired, resulting in a very economical overall process. The separation of the catalyst from the boron compounds after the reaction with BX₃ in the downstream microreactor 2 is generally a very simple task, since hydrolysis and setting of an alkali pH results in the boron compounds going into solution and the redox catalyst being able to be recovered quantitatively by extraction or filtration.

A further preferred method of preparing the organolithium compound in the microreactor 1 is the reaction of an organolithium compound which is either commercially available or generated in a “classical reactor” with a haloaromatic or haloaliphatic or a deprotonatable organic compound. Thus, for example, furyllithium can be prepared from furan by reaction with n-hexyllithium in the miroreactor 1, and this can then be reacted in the microreactor 2 with trialkyl borates to give furan-2-boronic acid. 2-Furanboronic acid is obtained in selectivities (relative to borinic acid, borane and tetrafurylboranate) of >98%.

The process of the invention is illustrated by the following examples without being restricted thereto:

### EXAMPLES 1-4

Boronic acids from n-hexyllithium, deprotonatable aromatics or aliphatics and B(OCH₃)₃

For the combination of a) deprotonation by means of hexyllithium and b) reaction with trimethyl borate, two of the microreactors described in example 1 were connected in series. The metallation mixture leaving the microreactor 1 was conveyed via a stainless steel capillary, internal diameter: 0.5 mm, length: 1.5 m, to the second reactor. The best results were obtained when the following flows and concentrations were chosen:

Microreactor 1: Inflow of a) reactant, c=1.0 mol/l: 10 l/h and b) n-hexyllithium in hexane, c=1.0 mol/l: 10 l/h Microreactor 2: Inflow of a) the above reaction mixture, c=0.5 mol/l: 20 l/h and b) trimethyl borate in THF, c=0.5 mol/l: 20 l/h

As standard conditions, the starting solutions and the reactors were cooled to −30° C. in a cold bath, since some of the organolithium compounds used react with the solvent THF at higher temperatures.

The results of a series of experiments are summarized in the table below:

| Ex- | | | | HPLC | Borinic |
|---|---|---|---|---|---|
| peri- | | | Yield | a/a | acid |
| ment | Substrate | Product | isolated | (purity) | content |
| 1 | Furan | 2-Furanboronic | 79.5% | 96.9% | <0.1% |
| | | acid | | | |
| 2 | Thiophene | 2-Thiophene- | 74.2% | 97.1% | <0.1% |
| | | boronic acid | | | |
| 3 | Fluorobenzene | 2-Fluorophenyl- | 88.1% | 96.9% | 0.9% |
| | | boronic acid | | | |
| 4 | Benzotrifluoride | 2-CF₃-phenyl- | 86.7% | 97.8% | 0.7% |
| | | boronic acid | | | |

### EXAMPLE 5

Preparation of Furan-2-boronic Acid

Firstly, a solution of lithium biphenylide in THF was prepared by stirring 0.25 mol of lithium granules and 0.27 mol of biphenyl in 500 ml of dry THF at −40° C. until the lithium metal had dissolved completely (7 h). The resulting solution (c=[lacuna]) was fed in parallel with a solution of furan (freshly distilled) in THF (c=0.5 mol/l) into a microreactor, with the reactor and the furan solution being cooled to −20° C. The micromixer used was a single micromixer comprising 25×300 μm and 40×300 μm nickel structures on a copper backing from the Institut für Mikrotechnik, Mainz. The outlet of the reactor was connected via a 1.5 m stainless steel capillary, internal diameter: 0.5 mm, to a similarly constructed microreactor which was likewise cooled to −20° C. and into which the trimethyl borate solution was fed in parallel to the lithiofuran solution formed in microreactor 1. The reaction mixture obtained was poured into water (pH=11.2), the pH was adjusted to 7.0 by means of 20% sulfuric acid and the solvents were distilled off under mild conditions at 120 mbar. The pH was subsequently adjusted to 9.0 to dissolve the product and to enable the biphenyl to be recovered by filtration at 5° C. The pH of pure boronic acid (5.2) was then set, and the boronic acid was isolated by filtration and dried at 40° C./110 mbar. Yield based on furan used: 59.2%; borinic acid was not detectable (<0.5%).

1. A process for preparing arylboron and alkylboron compounds of the formulae (II) and (III) by reacting lithioaromatics and lithiated aliphatics of the formula (I) with boron compounds in microreactors in accordance with equation I or equation II, 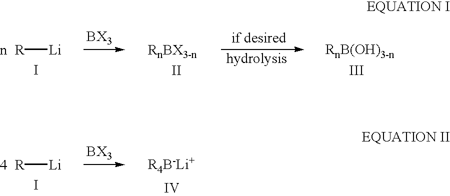
where X=identical or different radicals selected from the group consisting of fluorine, chlorine, bromine, iodine, C₁-C₅-alkoxy, N,N-di(C₁-C₅-alkyl)amino and (C₁-C₅-alkyl)thio,
n=1, 2 or 3,
and R=straight-chain or branched C₁-C₆-alkyl, C₁-C₆-alkyl substituted by a radical selected from the group consisting of RO, RR′N, phenyl, substituted phenyl, fluorine and RS, phenyl, phenyl substituted by a radical selected from the group consisting of C₁-C₆-alkyl, C₁-C₆-alkoxy, C₁-C₅-thioether, silyl, fluorine, chlorine, dialkylamino, diarylamino and alkylarylamino or
substituted or unsubstituted 6-membered heteroaryl containing one or two nitrogen atoms, or
5-membered heteroaryl containing one or two heteroatoms selected from the group consisting of N, O and S, or
a substituted or unsubstituted bicyclic or tricyclic aromatic, in one or more coolable/heatable microreactors connected in series whose outlet channels are, if necessary, connected to capillaries or flexible tubes which are a number of meters in length, with the reaction solutions being intensively mixed during a sufficient residence time.

2. The process as claimed in claim 1, wherein a homogeneous solution of an electron transferrer is firstly generated by stirring lithium metal in a solvent with an organic compound which can easily take up and transfer free valence electrons and this solution is reacted with a haloaromatic in the first microreactor and fed via a capillary or a flexible tube into a second, downstream microreactor and reacted with BX₃ there.

3. The process as claimed in claim 1, wherein the microreactors used are flow-through reactors whose channels have a diameter of from 25 μm to 1.5 mm.

4. The process as claimed in claim 1, wherein the flow rate in the microreactor is set so that a residence time of from one second to 10 minutes is achieved.

5. The process as claimed in claim 1, wherein the reaction is carried out at temperatures in the range from −60° C. to +30° C.

6. The process as claimed in claim 1, wherein two microreactors are connected in series and the residence time in the first reactor including the residence time in the capillary and tube systems on the way to the second reactor is set so that the conversion in the preparation of the organometallic compound is at least 90%.
The process as claimed in claim 1, wherein solutions having a concentration in the range from 1 to 35% by weight are used.

8. The process as claimed in claim 2, wherein the microreactors used are flow-through reactors whose channels have a diameter of from 25 μm to 1.5 mm.

9. The process as claimed in claim 2, wherein the flow rate in the microreactor is set so that a residence time of from one second to 10 minutes is achieved.

10. The process as claimed in claim 2, wherein the reaction is carried out at temperatures in the range from −60° C. to +30° C.

11. The process as claimed in claim 2, wherein two microreactors are connected in series and the residence time in the first reactor including the residence time in the capillary and tube systems on the way to the second reactor is set so that the conversion in the preparation of the organometallic compound is at least 90%.

12. The process as claimed in claim 2, wherein solutions having a concentration in the range from 1 to 35% by weight are used.

13. The process as claimed in claim 4, wherein the microreactors used are flow-through reactors whose channels have a diameter of from 25 μm to 1.5 mm.

14. The process as claimed in claim 13, wherein the flow rate in the microreactor is set so that a residence time of from one second to 10 minutes is achieved.

15. The process as claimed in claim 14, wherein the reaction is carried out at temperatures in the range from −60° C. to +30° C.

16. The process as claimed in claim 15, wherein two microreactors are connected in series and the residence time in the first reactor including the residence time in the capillary and tube systems on the way to the second reactor is set so that the conversion in the preparation of the organometallic compound is at least 90%.

17. The process as claimed in claim 16, wherein solutions having a concentration in the range from 1 to 35% by weight are used.
